(19) United States
(12) Patent Application Publication
(10) Pub. No.: US 2016/0297336 A1
(43) Pub. Date: Oct. 13, 2016

(54) HEAD RESTRAINT AND SEAT FOR ENHANCING TRAVEL COMFORT

(71) Applicant: Active Ally Active Ally Ltd., Riihimaki (FI)

(72) Inventors: Tapio SUOMI, Helsinki (FI); Lasse KORVALA, Helsinki (FI)

(21) Appl. No.: 14/892,895

(22) PCT Filed: May 30, 2014
(86) PCT No.: PCT/FI2014/050437

§ 371 Date: Nov. 20, 2015

(30) Foreign Application Priority Data
May 31, 2013 (FI) 20130155

(51) Int. Cl. B60N 2/48; B60N 2/24; B60R 22/32; B60R 22/20; B60R 22/30; B64D 11/06; B60R 22/26

(52) U.S. Cl. CPC B60N 2/4885; B64D 11/0646; B60N 2/242; B60R 22/26; B60R 22/20; B60R 22/30; B60R 22/32; B64D 11/062

(57) ABSTRACT

The present invention relates generally to travelling in a seat placed in a vehicle and is targeted to a head restraint (16) that is capable to prevent a prolonged flexion and a micro-trauma, comfort to use, and safe to use also in case of accident. This head restraint (16) comprises a first part (18) to be attached to a back rest or a headrest, a second part (19) to be attached to a user's head, and a pivot point (20) between the first part (18) and the second part (19). The head restraint (16) further comprises a fastener (41) and a safety release mechanism. The fastener (41) fastens the first part (18) and the second part (19) together at the pivot point (20), the fastener (41) being substantially nonelastic and configured to hold the user's head against the back rest or the headrest and to allow turning of the user's head. The safety release mechanism releases the user's head from the back rest or the headrest, the safety release mechanism being reusable and standardized to open not later than a force exceeds the predetermined upper limit, said force aiming to draw the user's head away from the back rest or the headrest. In addition to the head restraint, the invention comprises a seat to which the head restraint can be attached. The seat comprises a support for a seat accessory.

### TECHNICAL FIELD

The present invention relates generally to travelling in a seat placed in a vehicle, travel comfort, and to travel safety.

### BACKGROUND OF THE INVENTION

A vehicle seat may be uncomfortable when a traveller tries to sleep or rest in it. During the sleep the traveller's head may lean forwards or to the side so that the neck and upper-back become strained. This unnatural position of the head may cause pain. Moreover, a sudden vehicle movement causes an injury risk while the traveller is in sleep. An accident is one reason, but not the only possible reason for the sudden vehicle movement. For example, turbulence moves an aeroplane in a sudden way. In addition to sudden vehicle movements, a deceleration may jeopardize travel safety. Sometimes a driver of a car or bus needs to brake relatively hard to avoid an accident. This kind of normal use of the brake causes an injury risk when a traveller of the car or bus is in sleep.

US patent application 2010283310 (and WO2010129652) describes a head restraint device comprising a head band, a head restraint, an attachment band, and a fastener. The head band encircles a user's head and the attachment band encircles the seat or the headrest. The attachment band is coupled to the head restraint and the fastener is detachably coupled to the head band. The fastener can be implemented in various ways. Velcro is a brand name of fabric hook-and-loop fasteners. When the two sides of Velcro are pressed together, the hooks catch in the loops and hold the pieces together. The two sides can be later separated from one another upon a threshold amount of pulling force being applied to them. Alternatively, the fastener may comprise loops, buckles, clips, hooks, snaps, buttons, magnets, cam buckles, side release buckles, cord locks, O or D shaped rings, or a combination thereof.

U.S. Pat. No. 6,607,245 describes a head restraint for supporting a user's head with respect to the headrest portion of a seat. The head restraint has a headband for placing over the head across the forehead of the user. An anchor band is placed around the headrest portion of the seat. The head restraint further comprises two securement straps to hold the user's head in a certain position. A right-hand securement strap is affixed between the headband and the anchor band. Similarly, a left-hand strap is affixed between those bands.

A drawback related to US patent application 2010283310 and U.S. Pat. No. 6,607,245 is that the head restraint does not allow a user to turn his head. The user may feel that his head is fixed too firmly to a headrest or a back rest.

US design patent D694309 describes such head restraint in which a single band surrounds a back rest and a user's head. This head restraint allows turning of a head. One drawback related to the head restraint is, however, adjusting the length of the band surrounding the back rest and the user's head. The adjusting of the head restraint is difficult, because the user should first estimate the length of the band and then test whether the length is appropriate or not. If the band is too loose, it may slip and free a user's head.

As a part of the background of the invention it should be noticed that the applicant has already made known a following kind of rest band. The rest band comprises a first part and a second part which are connectable to each other by one or more press-studs. When the rest band is in use, the first part is coupled to the headrest of a seat and the second part encircles the user's head.

Also in a Japanese application JPH1024059 a head restraint comprises two parts which are termed a support belt and a head belt. The support belt is to be attached to a vehicle seat and the head belt to a user's head. The head restraint further comprises connection means to connect the belts together and to keep a user's neck stable when the vehicle is moving. For example, pieces of the velvet fasteners can be used as the connection means by placing these pieces on the support belt and the head belt. The implementation allows a user to slightly turn his head because there is a pivot point between a headrest and the user's head. Turning the head, however, may cause some noise, if the velvet fastener partly opens. Therefore, a drawback related to JPH1024059 is that the head restraint lacks such pivot point that allows turning a head without any noise. Another drawback is that when the user is sleeping, his/hers head may turn unintentionally so strongly that the velvet fastener fully opens. A man skilled in the art can eliminate this drawback by using a greater amount of velvet fastener in the head restraint. If the amount of the velvet fastener is increased, the user's head does not draw away from the head rest of the seat but this solution causes another problem. In case of accident a seat belt usually let the user's body to draw away from the seat before the seat belt stops this movement. If the user's body draws away from the seat, in case of accident, but his/hers head does not draw away from the seat, the user's neck is in dangerous.

U.S. Pat. No. 5,081,714 describes a vehicle internal safety belt for holding one's head against the headrest of a seat or for holding one's legs together. The solution comprises two identical belt bodies permanently connected to each other with a middle part. The middle part is an elastic band, thus it probably allows turning a head without any noise. In case of accident the middle part stretches. U.S. Pat. No. 5,081,714, however, does not mention that the middle part would snap in case of accident. Therefore, travel safety is not considered as in the above mentioned US2010283310. Another drawback related to U.S. Pat. No. 5,081,714 is that the head restraint does not provide a fully satisfied pivot point. Vehicle movements and the flexible middle part may cause that a traveller's head draw away from the seat. Therefore, the head restraint does not prevent prolonged flexion and micro-trauma. The micro-trauma can be described as stress loads placed on the spinal ligaments and tendons. Every time the traveller's head nods off or “surfs”, there is a potential to cause the micro-trauma to the ligaments holding up the neck.

U.S. Pat. No. 5,081,714 represents the closest prior art for the present invention. The objective technical problem is that a head restraint should be simultaneously 1) safe in case accident, 2) capable to prevent the prolonged flexion and the micro-trauma, and 3) comfort to use, wherein the last mentioned feature means that turning a head should be possible when using the head restraint.

Another problem related to the invention is attaching a head restraint to a seat. Usually, the head restraint (or its component) encircles the headrest or the back rest of the seat. If the backside of the seat, however, includes a display or a turnover table, the head restraint should not cover the display or disable the use of the turnover table. In addition to a head restraint, a pillow is a seat accessory which a user may need when travelling in a car, a bus, a train, an aeroplane, or in another vehicle. If the user is a child or a short person, the headrest is located too high for him/her.

CN2767246 provides a pillow solution for children and short persons. A pillow is coupled to two bands and can be moved along the bands upwards and downwards. Therefore, the height of the pillow from the bench can be adjusted. One drawback of the solution is that the pillow cannot easily detach from the seat. Another drawback of CN2767246 is that it does provide a solution for attaching a head restraint to a seat at an appropriate height.

### SUMMARY OF THE INVENTION

One aim of the invention is to solve the above-mentioned objective technical problem. Therefore, a head restraint should be simultaneously 1) safe in case accident, 2) capable to prevent the prolonged flexion and the micro-trauma, and 3) comfort to use.

One aspect of the invention is a head restraint for enhancing travel comfort in a seat, the head restraint comprising

a first part to be attached to a back rest or a headrest,

a second part to be attached to a user's head, and

a pivot point between the first part and the second part, wherein the head restraint further comprises

a fastener for fastening the first part and the second part together at the pivot point, the fastener being substantially non-elastic and configured to hold the user's head against the back rest or the headrest and to allow turning of the user's head; and

a safety release mechanism for releasing the user's head from the back rest or the headrest, the safety release mechanism being reusable and standardized to open not later than a force exceeds the predetermined upper limit, said force aiming to draw the user's head away from the back rest or the headrest.

In one embodiment the head restraint comprises a rotation part for rotating the second part in relation to the first part.

In one embodiment the rotating enables attaching of the first part in any angle to the back rest or the headrest.

In one embodiment the rotating enables leaning the user's head towards the user's shoulder.

In one embodiment the head restraint comprises a coupling part arranged between the fastener and the second part, the coupling part enabling a movement of the pivot point along the second part.

In one embodiment the fastener is a band that is permanently attached either to the first part or the second part and has at least one free end.

In one embodiment the fastener comprises at least one strip of hoop-and-loop fabric.

In one embodiment said at least one strip of hoop-and-loop fabric is a part of the safety release mechanism.

In one embodiment the safety release mechanism is located in the first part or the second part.

In one embodiment the head restraint comprises a lock that aims to hold the user's head against the back rest or the headrest in case of accident.

In one embodiment the lock operates as the fastener.

In one embodiment the predetermined upper limit is intended for a certain user group, users dividing into at least two groups on the basis of theirs masses.

In one embodiment the second part comprises an extension for covering the user's eyes.

In one embodiment the extension is foldable.

In one embodiment the head restraint comprises an attachment arrangement for attaching eye patches.

In one embodiment the second part is one of the following components: a band, a hoodie, a mask, a component comprising eyeholes, a component encircling at least partly a user's head.

In one embodiment the second part comprises at least one container.

In one embodiment said at least one container is intended for storing an earplug.

In one embodiment the head restraint further comprises a third part for avoiding the second part to slip on the user's neck.

In one embodiment the fastener is attachable to a support that is permanently attached on the back rest or the headrest.

In one embodiment the fastener is attachable to a support inlaid in the back rest or the headrest.

One aim of the invention is to provide a seat and a seat accessory which together solve the above-mentioned objective technical problem. A head restraint and a pillow are examples of the seat accessory attachable to the seat.

One aspect of the invention is a seat for enhancing travel comfort, the seat comprising at least a bench and a back rest, wherein the seat further comprises

a support for a seat accessory, the support being inlaid in the back rest, a headrest, or in a pillow and providing at least one point for attaching and detaching the seat accessory, said at least one point locating in an area of the back rest, the headrest, or the pillow against which a user leans when seated in the seat.

In one embodiment the seat accessory is a head restraint.

In one embodiment the seat accessory is a pillow when the support is inlaid in the back rest or the headrest.

In one embodiment the seat comprises an open space around the support to make easier said attaching and detaching.

In one embodiment the seat comprises at least one lapel for covering the support.

In one embodiment said at least one lapel is made of a cover material intended for seats.

In one embodiment the support provides a plurality of points for said attaching and detaching.

In one embodiment the plurality of points are located on a substantially vertical line inside the back rest or the headrest.

In one embodiment the support comprises an elongated part.

In one embodiment the elongated part is one of the following parts: a bar, a rail, a belt.

In one embodiment the support comprises one of the following parts: a loop, a hook, a magnet, a snap button.

In one embodiment seat comprises a fastener for said attaching and detaching.

### BRIEF DESCRIPTION OF THE DRAWINGS

For a more complete understanding of examples and embodiments of the present invention, reference is now made to the following descriptions taken in connection with the accompanying drawings in which:

FIG. 1 shows unnatural position of a traveller's head during sleep,

FIG. 2A shows a head restraint holding the head against a headrest,

FIG. 2B shows binding a head restraint to a movable pillow,

FIG. 2C shows a band permanently attached to a seat,

FIG. 3 shows a seat and the user from a bird's perspective,

FIG. 4A shows in which manner the user's head may turn,

FIG. 4B shows a movement of a pivot point,

FIG. 4C shows a fastener and a coupling part,

FIG. 4D shows a fabric hook-and-loop fastener,

FIG. 4E shows the fabric fastener from different angle,

FIG. 5 shows various locks for head restraints,

FIG. 6A shows a fastener that operates as a rotation part 61,

FIG. 6B shows another kind of rotation part,

FIG. 7 shows an extension for covering the user's eyes,

FIG. 8 shows a container for accessories of a head restraint,

FIG. 9 shows a part for avoiding the second part to slip on the user's neck,

FIG. 10A shows binding the parts of a head restraint together,

FIG. 10B shows binding a first part of a head restraint to a loop,

FIG. 10C shows a seat equipped with a head restraint support,

FIG. 10D shows the back rest of a seat,

FIG. 11 shows the headrest of a seat,

FIG. 12 shows a support comprising loops,

FIG. 13 shows a support comprising hooks,

FIG. 14A shows a support comprising a bar,

FIG. 14B shows the bar from a different view angle,

FIG. 14C shows the bar when a head restraint is attached to it,

FIG. 15 shows a fork having two prongs,

FIG. 16 shows a fastener comprising the fork, a rotation part, and a band.

### DETAILED DESCRIPTION OF THE INVENTION

It is appreciated that the following embodiments are exemplary. Although the specification may refer to “one” or “some” embodiment(s), the reference is not necessarily made to the same embodiment(s), or the feature in question may apply to multiple embodiments. Single features of different embodiments may be combined to provide further embodiments.

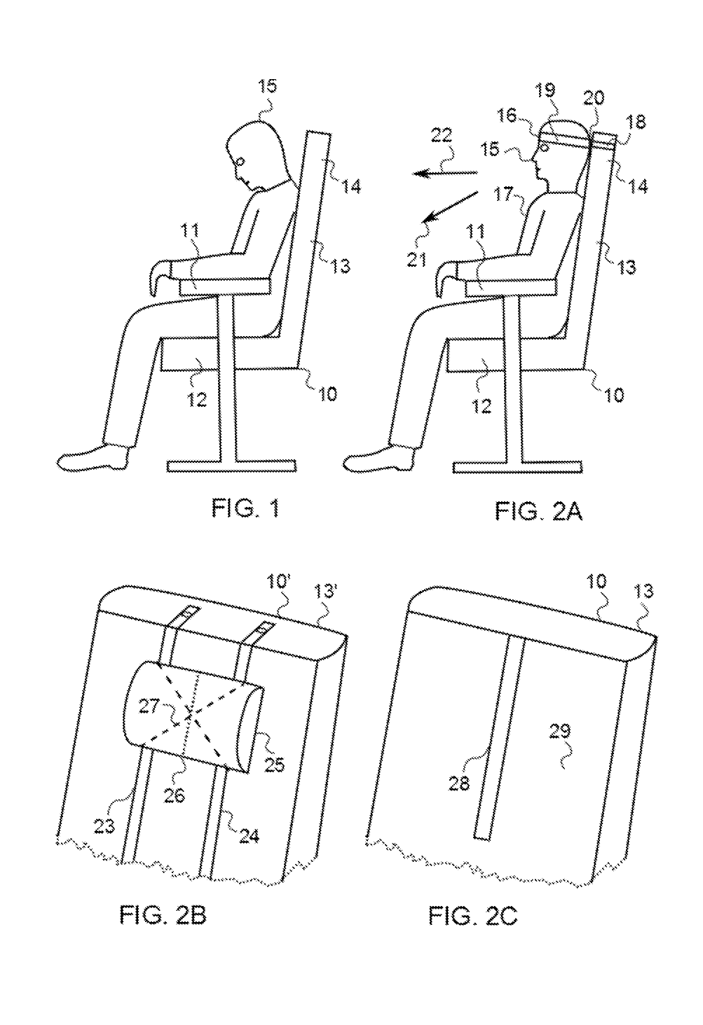

FIG. 1 shows a traveller sitting in a vehicle in a seat 10. The seat 10 includes an armrest 11 and thus represents a seat type which is typical in aeroplanes. A car, a bus, or a train may include a different looking seat. Generally speaking, a seat related to the present invention includes a bench 12 and a back rest 13 and it is intended for adults and/or children. A headrest 14 is an extension of the back rest 13. As generally known, the headrest 14 could be a separate (and adjustable) part of the seat 10. The back rest 13 is tilted backwards as far as possible. When the tilting angle between bench 12 and the back rest 13 is less than 120° (as in the figure) it is quite likely that during sleep the traveller's head 15 moves unintentionally to an unnatural position in which the traveller's jaw almost touches his chest. If the traveller's head 15 stays a relatively long time in this unnatural position, the traveller may suffer prolonged flexion and micro-trauma. Alternatively, the traveller wakes up at once when his head ends to the unnatural position. In other words, the traveller's sleep is interrupted.

FIG. 2A shows the seat 10 and the traveller using a head restraint 16. The head restraint user 17, or shortly a user, is the traveller shown in FIG. 1. The head restraint 16 comprises two functional parts: a first part 18 encircles the headrest 14 and a second part 19 encircles the user's head at forehead-level. The parts 18 and 19 are coupled to each other at a pivot point 20. The second part 19 can be opened or loosened to release the user's head from it. The first part 18 and the second part 19 are coupled to each other by a substantially non-elastic fastener to hold the user's head against the headrest 14. A basic idea in the implementation of the head restraint 16 is to either continuously hold the user's head against the headrest or release the user's head from the headrest by a specific safety release mechanism. The unnatural position of the head (shown in FIG. 1) can be avoided by using the head restraint 16. By preventing prolonged flexion and micro-trauma, the head restraint user's tissue suffer less episodes of stiffness thereby reducing joint pain during travel. During sleep the head 15 aims to lean, due to gravity, forwards and downwards from the headrest 14. The gravity causes a force 21 away from the headrest 14. Basically all vehicles have brakes and use of the brakes cause forces affecting people inside the vehicles. When a vehicle, in which user 17 is sitting, is moving forwards and its brakes are used, the vehicle's velocity is decelerated causing a force 22. The force 22 is increased, if the vehicle hits to some object. Therefore, in addition to the gravity, the use of the brakes and/or a possible accident of the vehicle affect user 17.

FIG. 2B shows binding the head restraint 16 to a movable pillow 25. Seat 10′ comprises two bands 23, 24 permanently attached to the back rest 13′ of the seat so that pillow 25 hangs on the bands and can be moved along the bands. In one embodiment head restraint 16 comprises a rotation part. Then the first part 18 of the head restraint can be attached to pillow 25 along a vertical dot line 26. Alternatively, when head restraint 16 comprises the rotation part and first part 18 is long enough, the first part 18 can be bind to seat 10′ so that it encircles bands 23, 24, and pillow 25 as illustrated with a cross 27.

FIG. 2C shows a support 28 permanently attached to seat 10. The attachment of the support 28 can be performed during the manufacturing of seat 10 or after it. Assuming that the second part 19 of head restraint 16 is attachable by a piece of hook-and-loop fastener to the first part 18, the first part 18 can be omitted because the seat 10 includes the support 28. Support 28 may be made of the same material as seat belts and the cover material of seat 10 is, for example, faux leather. The both ends of support 28 can be glued with so-called super glue to the cover of seat 10. Alternatively, if the upholstering 29 of seat 10 is detachable, support 28 can be sewed to upholstering 29. When attaching head restraint 16 to seat 10 a user pushes one free end of the hook-and-loop fastener between the band 28 and the seat 10 and attaches the second part 19 of the head restraint 16 to the band by using said fastener. In a corresponding manner, the user could attach a pillow or another seat accessory to seat 10.

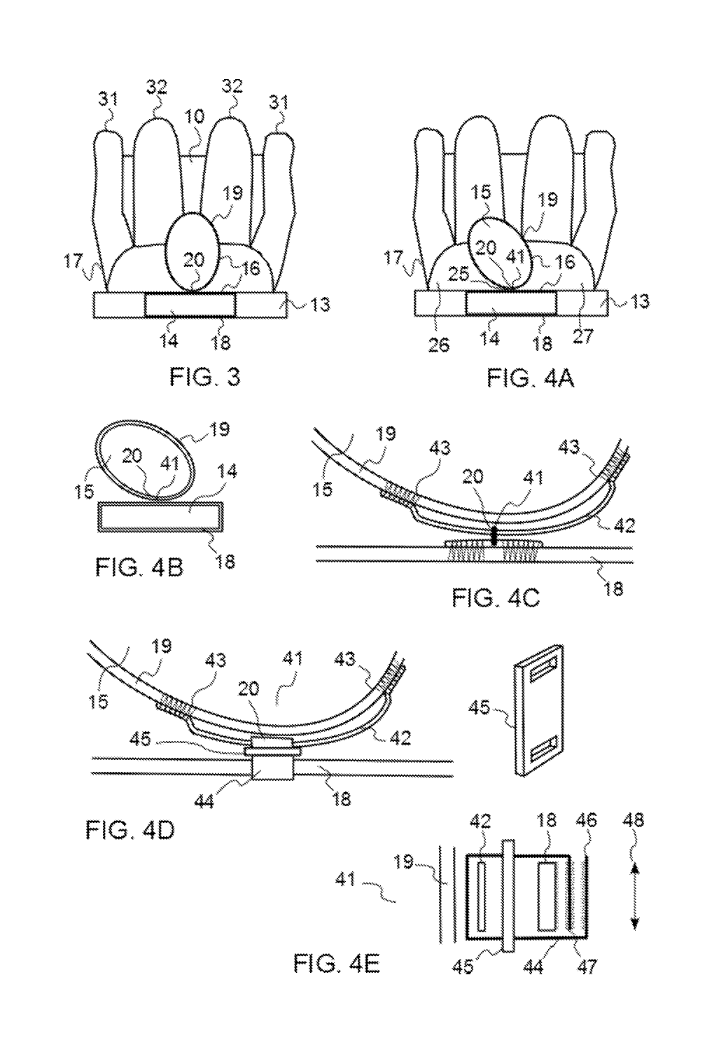

FIG. 3 shows the seat 10 and the head restraint user 17 from a bird's perspective. The head restraint user 17 keeps his hands 31 on armrests (the armrests not shown in the figure) and leans against the backrest 13. The user's legs 32 extend over the edge of the bench 12. The head restraint 16 keeps the head 15 against the headrest 14. At the pivot point 20 the first part 18 encircling the headrest 14 is coupled to the second part 19 encircling the head 15. In one embodiment the head restraint 17 comprises a small-sized pillow that can be placed between the head 15 and the headrest 14.

FIG. 4A shows from a bird's perspective the head 15 turned to left. The head restraint 16 comprises a fastener 41 that fastens the first part 18 and the second part 19 together at the pivot point 20. Due to the pivot point the head restraint 16 allows turning of head so that the left side 25 of the head 15 touches at least partly the headrest 14. Correspondingly, the head restraint 16 allows turning of head so that the right side of the head 15 touches at least partly the headrest 14. During sleep the turning of head is unintentional. The quality of the sleep or rest enhances because the user's head cannot end (in a normal situation) to the unnatural position shown in FIG. 1 and because the user can somewhat change his body's and head's position (by turning head). The traveller can use the head restraint 16 when he is sleeping or resting and also when he is awake and active. The traveller may, for example, like to look out a window of the vehicle or discuss with a co-traveller. The discussion and watching views through the window is more pleasant when turning of head is possible. The travel comfort provided by the head restraint 16 comprises therefore the enhanced quality of the sleep or rest as well as the opportunity to turn the head without opening or loosening the second part 19.

FIG. 4B shows a movement of fastener 41 and the pivot point 20. The user's head 15 is turned more to left than in FIG. 4A and thus the pivot point is now closer to the user's left ear. Generally speaking, the pivot point can move in relation to the head 15. The pivot point, however, cannot move in relation to the headrest 14, if the first part 19 is firmly attached to the headrest (and the fastener is fastened to the first part 19).

FIG. 4C shows the fastener 41 and a coupling part 42. The orientation of the head 15 and the viewing angle are the same as in FIG. 4B but the head and the head restraint are magnified. The fastener 41 fastens the first part 18 and the second part 19 together and forms the pivot point 20 between those parts. The coupling part 42 is arranged between the fastener 41 and the second part. The coupling part 42 enables movements of the pivot point along the second part. In more detail, the pivot point may move between the ends 43 of the coupling part. In this example the coupling part is a piece of band that is sewed at its ends 43 to the second part 19. The fastener 41 is a ring which is sewed to the first part 18 and which is penetrated by the coupling part 42. In another embodiment, the fastener 41 is either the first lock 50 or the second lock 50′.

FIG. 4D shows one embodiment in which the fastener 41 comprises a fabric piece 44 and a two-hole piece 45. Free ends of the fabric piece 44 are lead through the holes of the two-hole piece 45 so that the fastener 41 is attached to the coupling part 42 by means of the fabric piece 44 and the two-hole piece 45. On the right in FIG. 4D, the two-hole piece 45 is shown from a different angle.

FIG. 4E shows the same embodiment as FIG. 4D but the viewing angle is from the side of the seat. The ends 46, 47 of the fabric piece 44 comprise the hooks and loops, i.e. the fabric piece 44 is a hook-and-loop fastener. When the ends 46, 47 are pressed to together, the fastener 41 operates as the second lock 50′ and a predetermined amount of power is needed to detach the ends 46, 47 from each other. If a hook-and-loop area 48 is reduced on the ends 46, 47, less power is needed to open the lock. Correspondingly, if the hook-and-loop area 48 is increased, more power is needed to open the lock. In this manner it is possible to adjust and test the second lock 50′ before the manufacturing. When an appropriate area size for the hooks and loops is found, this area size is used in the manufacturing of the fastener 41. In the embodiment shown in FIG. 4D also the first part 18 comprises a piece of hook-and-loop fabric. The other end 47 of the fabric piece 44 comprises the hook-and-loop fabric on its both sides. Therefore, the end 47 of the fabric piece 44 fastens the fastener 41 (and the second part 19) to the first part 18.

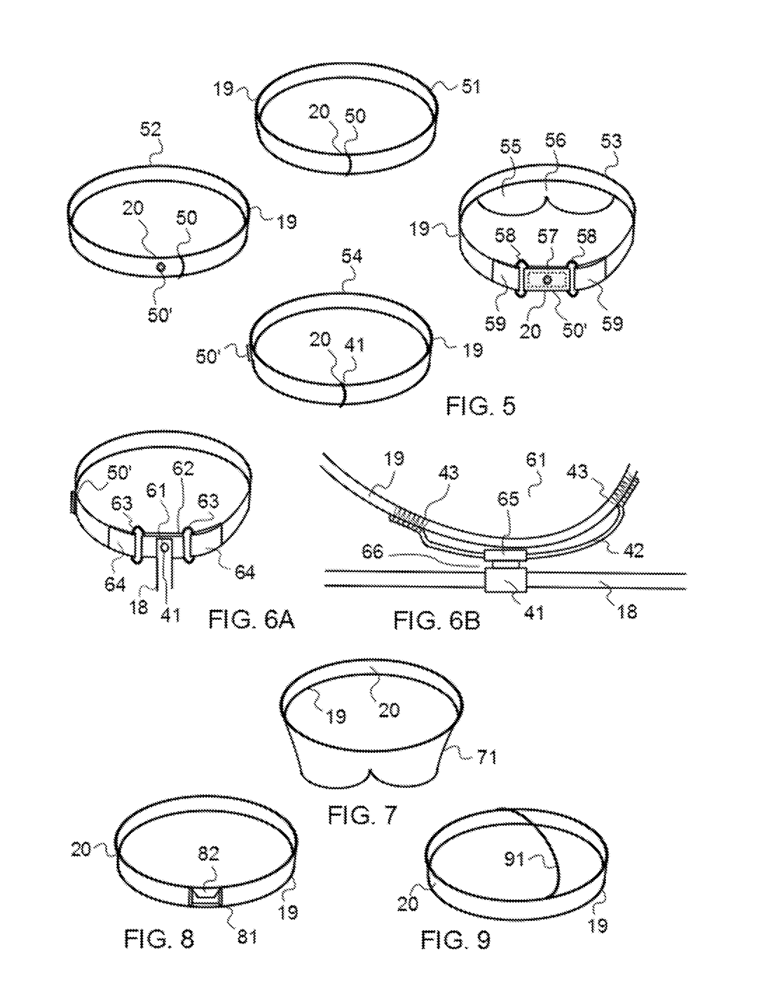

FIG. 5 shows various locks for the head restraint 16. In some embodiments the fastener 41 comprises a lock. The term “lock” refers to a component that can be repeatedly locked and opened (by hand), i.e. the lock is reusable. Sometimes, a deceleration causes a force that opens the lock without breaking it. A safety breakaway buckle is one example of the lock. Four different implementations of the head restraint 16 are referred with reference numbers 51-54.

A first lock 50 is intended to be used with such seat belts that keep a user tightly in a seat. This kind of seat belts is used, for example, in child safety seats and in sport cars. The first lock 50 should not open in case of accident. The first lock 50 aims to always hold the user's head against the seat.

A second lock 50′ can be considered as a part of the safety release mechanism and it can be used with or without a seat belt. The first lock 50 is probably safer than the second lock 50′, if a seat belt does not keep a user tightly in a seat. With another type of seat belts, or without a seat belt, the second lock 50′ is probably safer than the first lock 50. When a user does not wear the seat belt, a head restraint could be dangerous in in case of accident at which time the user's body may draw away from the seat. Then also the user's head should draw away from the seat. Therefore, the second lock 50′ is standardized to open when the force exceeds a predetermined upper limit.

The head restraints 51, 52 include a D-ring as the first lock 50 or as a part of it. The D-ring is, for example, sewed to the second part and the D-ring is intended to be used with a karabiner which is sewed to the first part of the head restraint. The head restraints 51 and 52 represent the second part 19 of the head restraint shown in FIG. 2.

The head restraints 52, 53 include a press-stud as the second lock 50′. The components 52 and 53 represent the second part 19 of the head restraint. In one embodiment, a user of the head restraint 52 should use the D-ring and the karabiner with a seat belt and the user should use the press-stud when he is not wearing a seat belt.

The head restraint 54 comprises a safety breakaway buckle as the second lock 50′ (the safety breakaway buckle is also known as a safety breakaway clip). The head restraint 54 further comprises a D-ring as the fastener 41. The D-ring couples the first part of the head restraint to the second part 19 at the pivot point. As shown in FIG. 2, the pivot point 20 locates close to the occipital of the head restraint user 17. In case of accident the second part 19 of the head restraint 54 opens close to the user's temple, at the second lock 50′ and releases the user's head. The first part of the head restraint 54 is, for example, a strap with two ends. The second lock 50′ is, for example, a cam buckle. The other end of the strap can be pushed couple of times through a D-ring attached to the second part. This is one possible manner to bind the first part to the second part of the head restraint.

As illustrated in FIG. 5, the head restraint 53 comprises eye patches 55 for covering the eyes when the user wants to rest. The middle point 56 of the eye patches 55 should be substantially opposite to the second lock 50′. Thus, position of the second lock 50′ is adjustable. The second lock 50′ is attached to a piece of band 57 which is coupled with two oval rings 58 to the second part 19. Therefore, the second part 19 of the head restraint 53 comprises two pieces of band and the oval rings between the pieces. The piece of band 57 is folded and sewed so that is holds the oval rings 58 in its grip. Also the ends 59 of the second part 19 are folded to hold the oval rings. The ends 59 comprise fabric hook-and-loop fasteners. The ends 59 are adjustable with the fabric hook-and-loop fasteners so that the circumference of the second part 19 is appropriate for the user's head and the middle point 56 of the eye patches 55 is opposite to the second lock 50′.

One aspect of the invention is shown in FIGS. 2, 3, 4, and 5. A user 17 of the head restraint 16 sits in a vehicle in a seat 10. The head restraint 16 comprises functionally a first part 18 and a second part 19 and the first part is coupled to the seat 10 and the second part 19 holds the user's head 15. The first part and the second part are coupled to each other at a pivot point 20 and the head restraint holds the user's head 15 against a headrest 14 or a back rest 13 and thus decreases probability that unintended movement of the user's head away from the headrest or the back rest causes prolonged flexion or micro-trauma. The pivot point 20 enables turning of the user's head so that the left side or the right side of the user's head touches at least partly the seat 10, in more detail, the headrest or the back rest. The pivot point further enables leaning of the user's head 15 towards the user's left shoulder 26 or right shoulder 27. In addition, one of the following four arrangements is usable:
a) the head restraint comprises only a first lock 50 that is intended to be used with a seat belt, the first lock aiming to hold the user's head against the headrest or the back rest in case of accident;
b) the head restraint comprises only a second lock 50′, the lock being standardized to open not later than said force exceeds a predetermined upper limit, the lock being placed in a present arrangement either in the first part or in the second part;
c) the head restraint comprises only the second lock 50′, a position of the lock being adjustable in the second part in relation to eye patches or an area to which the patches are attachable; or
d) the head restraint comprises the first lock 50 and the second lock 50′.

In one embodiment the second lock 50′ is standardized to open not until when a force directed away from the headrest exceeds a predetermined under limit. This embodiment relates to the quality of the lock. In more details, the lock should not open too easily.

In one embodiment the predetermined upper limit, which is relates to the opening of the second lock 50′, may be intended for a certain user group, such as children or adults. There may be a number of user groups according to certain user weight limits, for example, 1-10 kg, 11-20 kg, 21-30 kg etc.

In one embodiment head restraint 16 comprises a rotation part for rotating the second part in relation to the first part, wherein the rotation part is arranged between the first part and second part. By means of the rotation part the first part 18 of the head restraint 16 can usually be attached in any angle to the back rest or the headrest (FIG. 2B shows a couple of examples). The rotation part also enhances the travel comfort because, by using it, the user can lean his/hers temple more towards his shoulder 26, 27.

FIG. 6A shows a fastener 41 that also operates as a rotation part 61. Rotation part 61 makes possible to bind the head restraint to a seat in various manners as illustrated in FIG. 2B. Fastener 41 fastens the first part 18 and the second part 19 of the head restraint permanently together so that the first part 18 can be rotated in relation to the second part 19 (or vice versa). One end of the first part (not shown in the figure) comprises a hook-and-loop fastener for binding it to a seat. The head restraint comprises a safety breakaway buckle as the second lock 50′. The figure also illustrates in which manner the length of the second part 19 can be adjusted. The first part 18 is attached to a piece of a band 62 which is coupled with two oval rings 63 to ends 64 of the second part 19. The piece of band 62 is folded so that it holds the oval rings 63 in its grip. Also the ends 64 are folded to hold the oval rings. The ends 64 are adjustable with fabric hook-and-loop fasteners.

FIG. 6B shows another fastener 41 and another rotation part 61. The rotation part 61 comprises a sliding part 65 which is penetrated by the coupling part 42 and which may slide along the coupling part between the ends 43 of the coupling part. The rotation part 61 further comprises a rotating staple 66 which attaches the sliding part 65 to the fastener 41. The fastener 41 is made of hook-and-loop fabric and is similar to the fabric piece 44 shown in FIG. 4D. The fastener 41 attaches the first part 18 of the head restraint to the second part 19. By means of the rotating staple 66 the first part can be rotated in relation to the second part. In addition or alternatively, fastener 41 is be movable along the first part 18, which may make easier to affix the first part 18 to the seat and which may enhance travel comfort by allowing certain kinds of movements of head.

FIG. 7 shows an extension 71 for covering the user's eye. The second part 19 of the head restraint 16 comprises the extension 71. In one embodiment the extension is foldable away from the user's eyes. The figure also shows the pivot point 20 at which the second part 19 can be coupled to the first part of the head restraint.

FIG. 8 shows a container 81 for accessories of the head restraint 16. In one embodiment the container 81 is a small bag with a lid 82. The container can be used, for example, for storing an earplug or earplugs. Alternatively, the container can be used, for example, for storing a magnet or another material which may have some health effects. In one embodiment the second part 19 comprises at least one long container which can be filled with air. Then the second part 19 can be used as a pillow or as an air bag.

FIG. 9 shows a part 91 for avoiding the second part 19 to slip on the user's neck. The part 91 may be important especially for children. The seat in which the user of head restraint 16 sits may be a child safety seat.

In the above examples, the second part 19 of the head restraint is a band. There exist, however, other embodiments. The second part 19 may be a hoodie, a mask, a component comprising eyeholes and/or a month hole, or a component encircling at least partly a user's head. The band usually holds the user's head at forehead-level and the mask (covering the user's eyes) holds the head at eye-level.

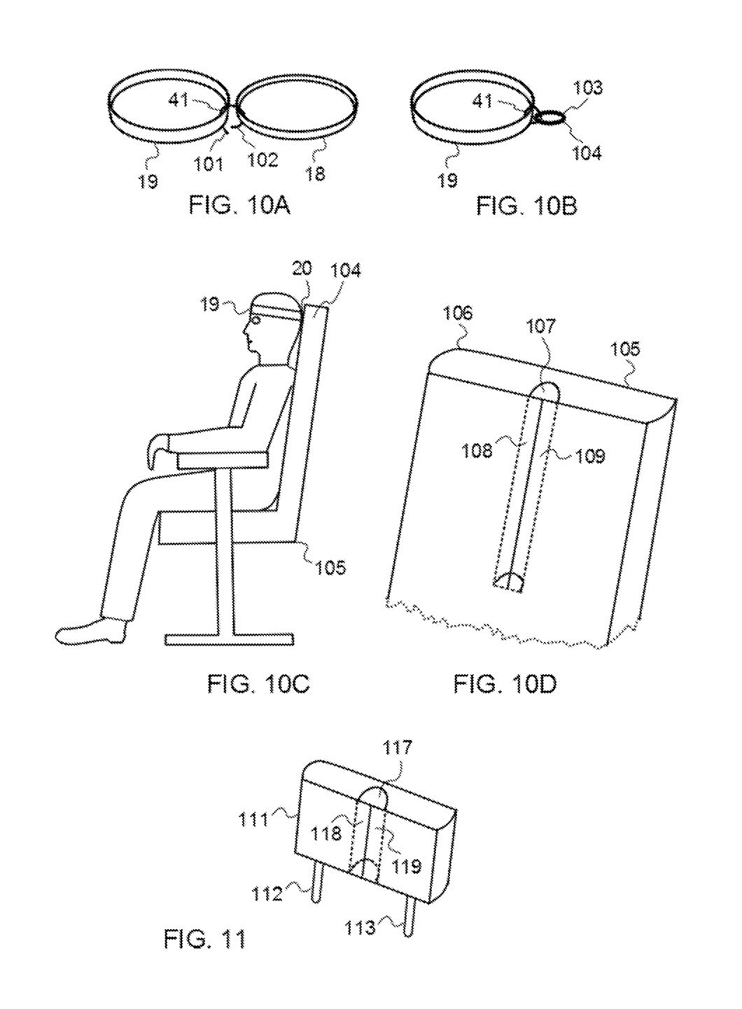

FIG. 10A shows a simple example of binding the parts 18, 19 of the head restraint together. Fastener 41 includes pieces of hook-and-loop fabric in its ends 101, 102. Ends 101, 102 and can be wrapped around the parts 18, 19 to fasten the parts together.

FIG. 10B shows an example of binding the first part 18 of the head restraint to a loop 103 which is inlaid a seat. Loop 103 is an example of a head restraint support 104, shortly support, to which a head restraint, a pillow, or another seat accessory can be attached. Ends 101, 102 of fastener 41 can be wrapped around the second part 19 and loop 103 to attach the head restraint to the seat.

FIG. 10C shows a seat 105 equipped with the support 104. In addition to the head restraint 16, the present invention comprises a new kind of seat 105 that includes, loop 103, a vertical bar, or some other support for a seat accessory. The support 104 is inlaid into the back rest and/or the headrest of seat 105 and provides points to which a head restraint or some other seat accessory can easily be attached. For example, fastening of the head restraint 16 is possible without the first part 18.

FIG. 10D shows the back rest 106 of seat 105. Back rest 106 includes an open space 107 which is extended from the top to the middle of back rest 106. Open space 107 is a vertical placket inside the back rest and contains the support 104 for seat accessories. This placket is, for example, 30 cm high, 4 cm wide and 4 cm deep. Support 104 is not visible in the figure because the open space 107 and the support 104 are covered by lapels 108, 109. Seat 105 comprises lapels 108, 109 for aesthetical reasons. The lapels are flexible and made of the same material as the cover of seat 105. Therefore, seat 105 looks like a regular seat having, for example, textile or faux leather as the cover material. Because support 104 is inlaid back rest 106, a user does not sense support 104 in his/hers back when he/she sits on seat 105 and leans against back rest 106. Therefore, seat 105 is comfortable to sit. If the user wants to use a seat accessory, such as head restraint 16, the user pushes his/hers fingers between lapels 108, 109 into the open space 107 to attach the seat accessory to support 104.

FIG. 11 shows a headrest 111 that can be used with a seat, for example, with seat 105. Two steel pipes 112, 113 of headrest 111 can be pushed into the seat for attaching the headrest to the seat. An open space 117 is also here a placket inside the headrest and contains a support 104 for seat accessories. Open space 117 is, for example, 15 cm high, 4 cm wide and 4 cm deep. Support 104 is not visible because it is covered by lapels 118, 119.

Correspondingly, pillow 25 shown in FIG. 2B could comprise an open space and lapels, and a support. In one embodiment a pillow, which comprises the open space, the lapels, and the support for seat accessories, is a kind of hood and this hood can be attached to a seat by pulling it over the headrest of the seat. The following examples concern back rests but as well they could concern headrests or pillows.

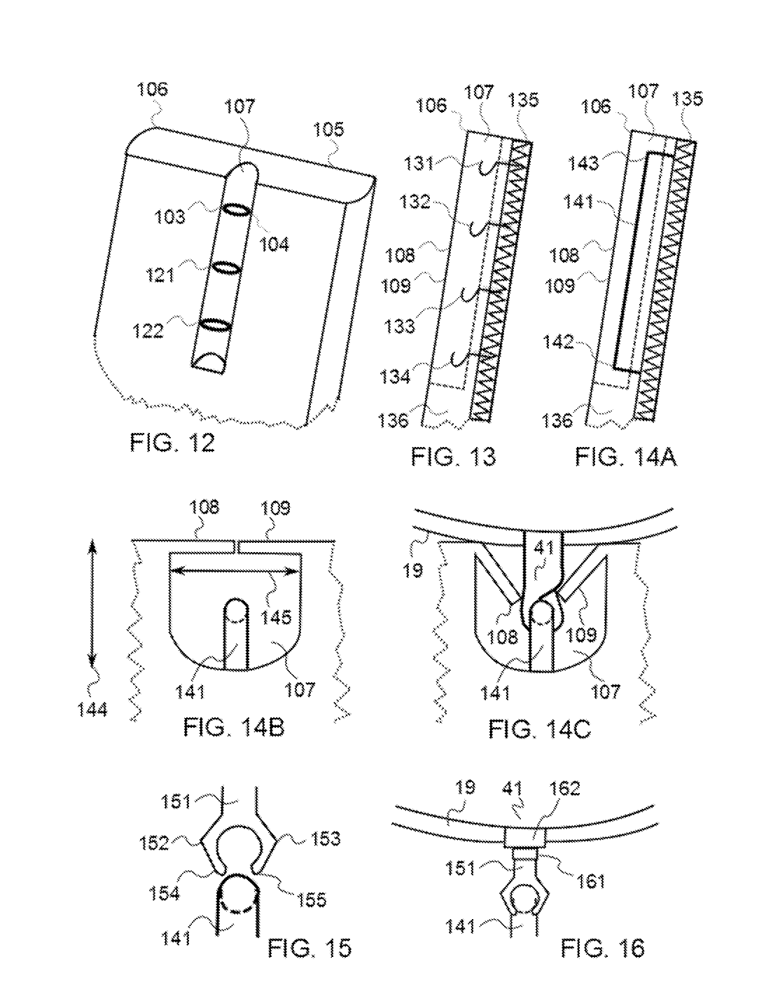

FIG. 12 shows an example of support 104 comprising loops 103, 121, and 122. Lapels 108, 109 are omitted from the figure to make the loops visible. When the open space 107 includes more than one loop (as in the figure) a seat accessory can be attached to the back rest 106 at different height from the bench of seat 105.

FIG. 13 shows an example of support 104 comprising hooks 131-134. The view angle is from the side of seat 105 as in FIG. 10C. In this example seat 105 comprises a body 135 made of plastic and cushion 136 between the cover material and body 135. Each hook 131-134 contains a screw in its other end, and by means of these screws the hooks are attached to the body 135. A dashed line illustrates the border of an open space 107 that is located under lapels 108, 109. The open space is formed into seat 105 by omitting or removing a slice of cushion 136. The size of this slice is, for example, 30 cm×4 cm×4 cm.

FIG. 14A shows an example which is similar to support 104 in FIG. 13 but hooks 131-134 are replaced with a bar 141 made of stainless steel. Bar 141 is twisted at two points 142, 143 near its ends and the ends of the bar 141 are attached to the body 135 of the seat. A man skilled in the art knows various solutions for attaching the bar 141 in a reliable manner to a seat.

FIG. 14B shows the bar 141 when a view angle is parallel to the bar (from point 142 towards point 143 as shown in FIG. 14A). The depth 144 of the open space 107 is 4 cm and also the width 145 of the open space 107 is 4 cm.

FIG. 14C shows the bar 141 from the same view angle as in FIG. 14B. Now a user has attached the second part 19 of the head restraint to bar 141 with fastener 41. Fastener 41 is wrapped around the part 19 and the bar 141 for attaching the head restraint to the seat. Due to the fastener, the lapels 108, 109 are bended towards the bar 141.

Fastener 41 may be included in the support 104, such as the bar 141. Then the fastener is a part of the seat and a user can (on demand) use it. Fastener 41 can be implemented in various manners, for example, by using a fork.

FIG. 15 shows a fork 151 comprising two prongs 152, 153. The distance between the ends 154, 155 of the prongs 152, 153 is less than the width of the bar 141. Fork 151 is made of plastic so that prongs 152, 153 of the fork are bendable but aim to return to their original orientation. A user can attach fork 151 to bar 141 by pushing the fork against the bar. Correspondingly, the user can detach the fork by pulling it. In one embodiment the fork operates as the second lock 50′.

FIG. 16 shows the fastener 41 comprising the fork 151, a rotation part 161, and an attachment band 162 which includes hook-and-loop fabric. Fork 151 is attached to bar 141 and the prongs 152, 153 of fork 151 partly around the bar. Fork 151 stays where it is, i.e. there is enough friction between the fork and the bar. Due to this friction the height adjusting of fastener 41 can be performed by sliding the fork along the bar (upwards or downwards). By means of rotation part 161 the attachment band 162 can be rotated in relation to fork 141, which makes easier to attach different seat accessories to the support 104.

It should be noticed that the lengths (4 cm, 10 cm etc.) and the materials (stainless steel, plastic etc.) mentioned in the above are examples and the head restraint and/or the seat in accordance with the present invention can be implemented in a different manner using different materials. In addition, while the invention has been described in connection with a number of exemplary embodiments, and implementations, the invention is not so limited, but rather covers various modifications, and equivalent arrangements, which fall within the purview of prospective claims.

1-33. (canceled)

34. A head restraint for enhancing travel comfort in a seat, the head restraint comprising
a first part to be attached to a back rest or a headrest of the seat,
a second part to be attached to a user's head, and
a pivot point between the first part and the second part, wherein the head restraint further comprises
a fastener for fastening together the first part and the second part at the pivot point, the fastener comprising a fixed part and a moving part to be attached to the fixed part, wherein the fastener is configured to hold a user's head against the back rest or the headrest and to allow turning of the user's head; and
a safety release mechanism for releasing the user's head from the back rest or the headrest, the safety release mechanism being reusable and calibrated to open in response to a force exceeding a predetermined limit, said force aiming to draw the user's head away from the back rest or the headrest.

35. The head restraint as claimed in claim 34, wherein the head restraint comprises a rotation part for rotating the second part in relation to the first part.

36. The head restraint as claimed in claim 34, wherein the head restraint comprises a coupling part arranged between the fastener and the second part, the coupling part enabling a movement of the pivot point along the second part.

37. The head restraint as claimed in claim 34, wherein the fastener is a band that is permanently attached either to the first part or the second part and has at least one free end.

38. The head restraint as claimed in claim 34, wherein the fastener comprises at least one strip of a hoop-and-loop fastener.

39. The head restraint as claimed in claim 34, wherein the safety release mechanism is located in the first part or the second part.

40. The head restraint as claimed in claim 34, wherein the head restraint comprises a lock that aims to hold the user's head against the back rest or the headrest in case of accident.

41. The head restraint as claimed in claim 34, wherein the second part comprises an extension for covering the user's eyes.

42. The head restraint as claimed in claim 34, wherein the second part is selected from a group consisting of a band, a hoodie, a mask, a component comprising eyeholes, a component encircling at least partly a user's head, and any combination thereof.

43. The head restraint as claimed in claim 34, wherein the head restraint further comprises a third part for preventing the second part from slipping onto the user's neck.

44. The head restraint as claimed in claim 34, wherein the fastener is attachable to a support that is permanently attached to the back rest or the headrest.

45. The head restraint as claimed in claim 34, wherein the fastener is attachable to a support disposed in in the back rest or the headrest.

46. A seat for enhancing travel comfort, the seat comprising at least a bench and a back rest, wherein the seat further comprises
a support coupled to the headrest, or the backrest, the support having at least one attachment point for detachable attachment of a seat accessory, said at least one attachment point being disposed in an area of the back rest or the headrest, against which a user leans when seated in the seat, the seat further comprising inside itself an open space around the support for making easier said detachable attachment of the seat accessory.

47. The seat as claimed in claim 46, wherein the seat accessory is a head restraint.

48. The seat as claimed in claim 46, wherein the seat accessory is a pillow.

49. The seat as claimed in claim 46, wherein the head rest comprises a pillow and said at least one attachment point is disposed in the pillow.

50. The seat as claimed in claim 46, wherein the support provides a plurality of attachment points for attaching and detaching said seat accessory.

51. The seat as claimed in claim 46, wherein the support comprises an elongated part.

52. The seat as claimed in claim 46, wherein the support comprises one of the following parts: a loop, a hook, a magnet, a snap button.

53. The seat as claimed in claim 46, wherein the seat comprises a fastener for said detachable attachment of the seat accessory.
